(19) United States
(12) Patent Application Publication
(10) Pub. No.: US 2018/0162037 A1
(43) Pub. Date: Jun. 14, 2018

(54) MOLDING DEVICE FOR EXECUTING HOT-MOLDING AND COLD-MOLDING METHODS

(71) Applicant: SIDEL PARTICIPATIONS, Octeville-Sur-Mer (FR)

(72) Inventor: Nicolas CHOMEL, Octeville-Sur-Mer (FR)

(21) Appl. No.: 15/838,599

(22) Filed: Dec. 12, 2017

(30) Foreign Application Priority Data
Dec. 12, 2016 (FR) 1662328

(51) Int. Cl. B29C 49/48

(52) U.S. Cl. CPC B29C 49/4823; B29C 49/48; B29L 2031/7158; B29C 2049/4841; B29C 2049/4858; B29C 2049/4828

(57) ABSTRACT

Disclosed is a device for molding containers made of thermoplastic material including: a shell-carrier designed to accommodate an interchangeable molding shell including a bearing face resting against a support face of the shell-carrier; a cold-molding shell whose bearing face is shaped to be directly in contact with the support face; and a cooling unit for each shell-carrier. Moreover, the device includes: a hot-molding shell equipped with a heating unit that heat its bearing face; and thermal insulation interposed between the bearing face of the hot-molding shell and the support face of the shell-carrier.

### TECHNICAL FIELD OF THE INVENTION

The invention relates to a device for molding containers made of thermoplastic material, in particular by blow molding, comprising:
At least one shell-carrier, on which an interchangeable molding shell is designed to be mounted, with said shell comprising an inner face equipped with a molding impression and an outer bearing face resting against an inner support face of the shell-carrier,
At least one cold-molding shell whose bearing face is shaped to be directly in contact with the support face of the shell-carrier when it is mounted,
Means for cooling each shell-carrier that make it possible to cool the associated cold-molding shell by heat conduction between the support face and the bearing face.

### TECHNICAL BACKGROUND OF THE INVENTION

In a known manner, the molding devices of this type make it possible to produce containers, such as bottles, from preforms made of thermoplastic material. The preforms are heated in advance to a glass transition temperature so as to make them malleable enough. The thus heated preform is inserted into the impression of the shells of the molding device, and then a blow-molding nozzle injects a pressurized forming fluid, generally air, into the preform so that the walls of the latter take up the impression made in the inner face of the shells.

When the container is designed to be filled with a liquid at ambient temperature, for example at less than 25° C., a cold-molding method is executed. Immediately shaped into a container, the material that constitutes the walls of said container is then cooled quickly in the mold to a relatively low set-point temperature, for example between 7° C. and 40° C., so as to freeze the shape thereof definitively.

However, the heat that is provided by the preform, heated in advance to a temperature that is higher than 85° C. and that can range up to 130° C., has a tendency to increase the temperature of the molding impression beyond the set-point temperature that is necessary to freeze the plastic material. In addition, when the molding device is used in an installation for mass-producing containers, numerous blow-molding cycles are carried out successively in a very short period of time. The rest period between two cycles is much shorter than the time necessary for evacuating the calories accumulated by the molding shells.

To avoid this problem, it is therefore known to equip the molding devices with cooling means, for example a heat exchanger that comprises channels for circulating a coolant.

With the manufacturing of molds comprising such cooling channels being very cumbersome, it is known to produce the molding device in at least two parts, namely a cold-molding shell comprising the molding impression and a shell-carrier comprising means for cooling the molding shell. Thus, it is possible to modify the format of the impression by changing only the cold-molding shell and by preserving the shell-carrier. Heat is evacuated by conduction between an outer face of the cold-molding shell that is in contact with an inner face of the shell-carrier.

When the plastic containers are to be filled with a hot liquid, a container that is molded by a cold-molding method runs the risk of retracting and deforming the container. To prevent this retraction phenomenon, it is known to execute a hot-molding method. In such a method, the hot-molding shell is to be heated to a specified temperature, for example between 110° C. and 150° C., during the molding operation so as to impart a heat-resistant structure to the plastic material constituting the container.

Various means of heating the hot-molding shell are already known. It is thus known to heat the hot-molding shell by means of a fluid circuit that is made in the thickness of the mold. A hot coolant supplies the circuit so as to heat the hot-molding shell.

It is also known to arrange electric heating resistors in the thickness of the hot-molding shell so as to heat the mold electrically.

However, when such a hot-molding shell is used in a shell-carrier that is equipped with cooling means suitable for hot-molding, a portion of the heat produced by the heating means is lost by heating the coolant that is contained in the cooling means.

### BRIEF SUMMARY OF THE INVENTION

The invention proposes a molding device of the type described above, characterized in that it comprises:
At least one hot-molding shell designed to replace the cold-molding shell on the shell-carrier, each hot-molding shell being equipped with means for heating the impression that heat at least one heated zone of its bearing face;
Thermal insulation means that are interposed between at least the heated zone of the bearing face of the hot-molding shell and the support face of the shell-carrier.

According to other characteristics of the invention:
The thermal insulation means comprise an air layer that is preserved between the heated zone of the bearing face of the hot-molding shell and the support face of the shell-carrier;
The air layer is preserved by means of shims that are inserted between the bearing face of the hot-molding shell and the support face of the shell-carrier;
Each shim is made of a thermally-insulating material such as the glass fiber;
The shims cover less than 10% of the surface of the support face of the shell-carrier;
The shims are attached to the shell-carrier;
The bearing face of the cold-molding shell comprises housings of a shape that is complementary to the shapes of the shims to allow the bearing face of the cold-molding shell to be brought into contact with the support face of the shell-carrier to which the shims remain attached;
The cooling means are designed to cool the entire surface of the support face of the shell-carrier;
The thermal insulation means cover the entire bearing face of the hot-molding shell;
The bearing face of the hot-molding shell comprises at least one cooled zone that is directly in contact with the support face of the shell-carrier to be cooled by the cooling means;
The means for cooling the shell-carriers are formed by at least one channel network in which a coolant circulates;
The means for heating each hot-molding shell are formed by at least one electric heating resistor housed in the thickness of the hot-molding shell.

### BRIEF DESCRIPTION OF THE FIGURES

Other characteristics and advantages of the invention will emerge when reading the following detailed description for the understanding of which reference will be made to the accompanying drawings in which:

FIG. 1 is a perspective view that shows a set of two complementary molding shells;

FIG. 2 is an exploded perspective view that shows a molding shell and an associated shell-carrier on which the shell is designed to be mounted in an interchangeable manner;

FIG. 3 is a vertical longitudinal cutaway view along the cross-sectional plane 3-3 of FIG. 2 that shows a cold-molding shell that is mounted on the shell-carrier of FIG. 2, with the molding device being made according to first and second embodiments of the invention;

FIG. 4 is a view that is similar to that of FIG. 3 that shows a hot-molding shell that is mounted on the shell-carrier of FIG. 2, with the molding device being produced according to any one of a first, second or third embodiment of the invention;

FIG. 5 is a view that is similar to that of FIG. 3, which shows a cold-molding shell that is mounted on the shell-carrier of FIG. 2, with the molding device being produced according to a third embodiment of the invention;

FIG. 6 is a view that is similar to that of FIG. 3, which shows a hot-molding shell that comprises cooled zones.

### DETAILED DESCRIPTION OF THE FIGURES

In the description below, longitudinal, vertical and transversal orientations, indicated by the “L, V, T” trihedron of the figures, will be adopted in a non-limiting way. The vertical orientation is used as a geometric reference point with no relation to the direction of gravity.

In the description below, elements exhibiting an identical structure or analogous functions will be referred to by the same references.

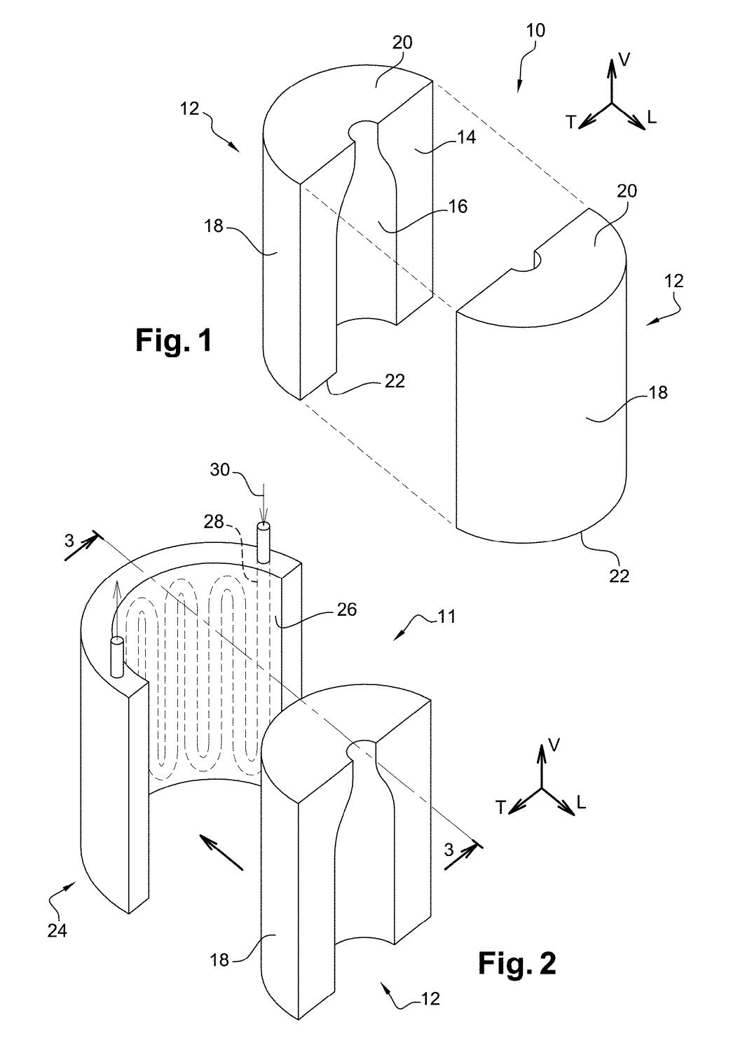

Shown in FIG. 1 is a set 10 of complementary molding shells 12 designed to equip a molding device 11 by blow molding containers made of thermoplastic material. Each molding shell 12 comprises an inner face 14 that is equipped with a part of a molding impression 16 of a container, and an outer bearing face 18 that is opposite to the inner face 14.

Each shell 12 very particularly exhibits a semi-cylindrical shape with a vertical axis “A.” Concerning a set 10 comprising two molding shells 12, the inner face 14 is a transversal flat face here. The two shells 12 are designed to be attached by flat contact between their inner faces 14 to restore the complete impression of the container.

It will be noted here that the shells 12 are designed to be completed by a mold bottom impression (not shown) that will make it possible to shape the bottom of the container.

The outer face 18 has a semi-cylindrical shape.

Each shell 12 is also delimited by a flat upper end face 20 and by a flat lower end face 22. The impression 16 of the container emerges in the upper face 20 to allow the injection of pressurized blow-molding fluid, while the impression 16 of the container emerges downward to be closed by the mold bottom.

Each shell 12 of the set 10 is designed to be mounted in an interchangeable manner on an associated shell-carrier 24, as is illustrated in FIG. 2. Thus, it is easy to change the set 10 of shells 12 when it is desired to form containers of different formats and/or to execute a different molding method, as will be explained below.

The shell-carrier 24 comprises an inner bearing face 26 against which the outer bearing face 18 of the shell 12 is designed to rest longitudinally. Actually, when the two shells 12 of the set 10 are attached and when a blow-molding fluid is injected under pressure into the container that is to be formed, the fluid exerts a pressure that tends to separate the two shells 12 longitudinally from one another. The shell-carrier 24 is designed to take up all of the separating forces exerted on the shells 12 in order to transmit them to the shell-carrier supports 24 (not shown).

The molding device 11 shown in FIGS. 2 to 6 is designed to execute easily both a cold-molding method and a hot-molding method.

When a container is made by a cold-molding method, the molding impression 16 is kept at a relatively low temperature, for example between 7° C. and 40° C.

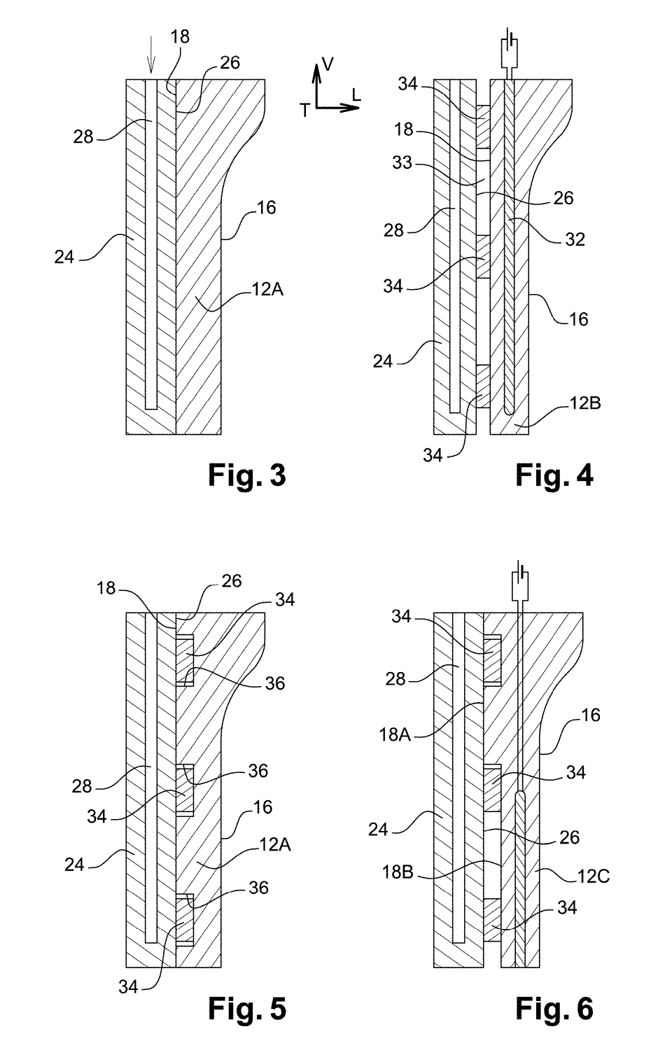

For this purpose, the molding device 11 comprises at least one set 10 of cold-molding shells 12A. The outer bearing face 18 of the cold-molding shells 12A is shaped so that essentially all of its surface is directly in contact with the inner support face 26 of the shell-carrier 24 when it is mounted, as illustrated in FIG. 3. Thus, the majority of the heat accumulated in the cold-molding shell 12A is transmitted via conduction to the shell-carrier 24 through the support face 26 in contact with the bearing face 18.

The separating forces applied to the cold-molding shell 12A are thus transmitted directly to the shell-carrier 24.

As is shown in FIGS. 2 to 6, the shell-carrier 24 is also equipped with cooling means that make it possible to evacuate the heat that is transmitted via the cold-molding shell 12A. Thus, the means for cooling each shell-carrier 24 make it possible to cool the associated cold-molding shell 12A by heat conduction between the support face 26 and the bearing face 18.

The cooling means are designed here to cool the entire surface of the support face 26 of the shell-carrier 24.

In the embodiment shown in the figures, the cooling means are formed by at least one heat exchanger that comprises a channel network 28 in which a coolant circulates. The channels 28 are made in the thickness of the shell-carrier 24, and they meander close to the support face 26 in order to promote the evacuation of heat.

When a container is made by a hot-molding method, the molding impression 16 is kept at a relatively high temperature, for example between 110° C. and 150° C.

For this purpose, the molding device 11 comprises at least one set 10 of hot-molding shells 12B. Each hot-molding shell 12B is designed to replace the cold-molding shell 12A on said shell-carrier 24. Each hot-molding shell 12B is equipped with means for heating the impression that heat at least one heated zone of its bearing face 18.

The means for heating each hot-molding shell 12B are formed by at least one electric heating resistor 32 housed in the thickness of the shell 12B, as is shown in FIG. 4. Each resistor 32 is formed by, for example, a vertical rod that is supplied with electricity by the upper face 20 of the hot-molding shell 12B.

In a variant of the invention, not shown, the heating means are formed by a network of channels made in the thickness of the hot-molding shell and in which a heating fluid circulates.

In general, a coolant 30 that is contained in the channels 28 of the means for cooling the shell-carrier 24 is not purged for reasons of costs and time in carrying out the operation. However, the coolant 30 runs the risk of absorbing a portion of the heat produced by the heating means. This therefore brings about an increased consumption of energy for keeping the hot-molding shell 12B at the specified high temperature.

In addition, to prevent the coolant from undergoing a phase change because of excess heating, it is kept moving in the channels 28. This emphasizes the overconsumption effect mentioned above.

In addition, the heat produced by the heating means is able to be transmitted to various elements of the facility at which the molding device 11 is installed, at the risk of degrading certain components of the facility, such as the bearings that ensure the opening and closing of the molding device, and/or endangering the operators who work at the facility.

To be able to use the hot-molding shells 12B on the same shell-carrier 24 as the cold-molding shells 12A, the molding device 11 is equipped with thermal insulation means that are interposed between at least the heated zone of the bearing face 18 of the hot-molding shell 12B and the support face 26 of the shell-carrier 24.

In the examples shown in the figures, the thermal insulation means are formed by a layer 33 of inert air preserved between the heating zone of the hot-molding shell 12B and the support face 26 of the shell-carrier 24.

As a variant, the air layer 33 is put into motion between the zone for heating the hot-molding shell 12B and the support face 26 of the shell-carrier 24 in order to evacuate the calories.

In another variant of the invention, not shown, the air layer is filled with a thermally-insulating material.

To be able to preserve the transmission of the bearing force of the hot-molding shells 12B to the associated shell-carrier 24, the air layer 33 is preserved by means of shims 34 that are inserted between the bearing face 18 of the hot-molding shell 12B and the support face 26 of the shell-carrier 24. The separating forces exerted on the hot-molding shell 12B are thus transmitted to the shell-carrier 24 by means of the shims 34. The shims 34 make it possible to separate longitudinally the bearing face 18 of the hot-molding shell 12B from the support face 26 of the shell-carrier 24.

Each shim 34 is made of a thermally-insulating material such as the glass fiber. Such a material has, for example, a thermal conductivity coefficient that is less than approximately 1 W·m⁻¹·K⁻¹.

As a variant, each shim can be produced integrally with the shell and/or with the shell-carrier, for example by machining in the area of the bearing face of the shell or in the area of the support face of the shell-carrier 24. Such a machining makes it possible to decrease the contact surfaces and therefore to decrease the heat exchanges.

The thermal insulation means thus cover the entire bearing face 18 of the hot-molding shell 12B since each portion of the bearing face 18 is either in contact with the air layer 33 or in contact with a thermally-insulating shim 34.

Each shim 34 has, for example, a segment shape that marries the shape of the support face 26. As shown in the figures, the shims 34 are distributed vertically here in three overall transverse rows, namely an upper row, a central row, and a lower row. Each row advantageously has multiple separated shims 34 so as to reduce the surface that these shims 34 cover. For example, each row comprises three shims 34 that are separated transversely from one another.

According to a first embodiment of the invention that is shown in FIGS. 3 and 4, the shims 34 are supported by the outer support face 18 of each hot-molding shell 12B. Thus, when a cold-molding shell 12A is mounted in the shell-carrier 24, its entire surface is in contact with the support face 26.

When the hot-molding shell 12B that is equipped with shims 34 is mounted on the shell-carrier 24, its bearing face 18 is separated from the support face 26 to preserve the insulating layer 33 of air. Thus, the heat that is produced by the heating resistor 32 is for the most part used to heat the impression 16.

The molding device 11 that is made according to this first embodiment makes it possible to change the molding method easily by simple replacement of the molding shells 12A, 12B.

Nevertheless, this first embodiment makes it necessary to equip all of the hot-molding shells with shims 34, which can prove cumbersome when the container manufacturer can produce numerous container formats by hot-molding and/or when the facility comprises numerous molding devices, as is the case, for example, of rotary blow-molding machines.

According to a second embodiment of the invention, the shims 34 are attached in a detachable manner on the bearing face 18 of the hot-molding shell 12B.

Thus, it is possible to use only one or two sets of shims 34 for each collection of hot-molding shells of different formats.

As a variant, the shims are attached in a detachable manner on the support face 26 of the shell-carrier 24.

In this second embodiment, the installation and the operation of the molding device 11 are identical to those that were described in the first embodiment, with the difference that it is necessary to mount or remove the shims 34 during a change between a cold-molding method and a hot-molding method.

This second embodiment thus makes it possible to reduce the manufacturing cost of the molding device 11, but it requires operations for mounting and removing shims.

According to a third embodiment of the invention, which will be described with reference to FIGS. 4 and 5, the shims 34 are supported by the support face 26 of the shell-carrier 24.

The shims 34 are permanently attached here to the shell-carrier 24. Thus, the shims 34 are designed to remain attached to the shell-carrier 24 during operations for replacing shells 12, regardless of the type of shell, for hot-molding or for cold-molding.

When a hot-molding shell 12B is mounted on the shell-carrier 24, as shown in FIG. 4, its support face 18 is insulated thermally from the support face 26 by the air layer 33.

Unlike the first two embodiments, the bearing face 18 of the cold-molding shell 12A comprises housings 36 of a shape that is complementary to the shape of the shims 34 to make it possible to bring the bearing face 18 of the cold-molding shell 12A into contact with the support face 26 of the shell-carrier 24 without removing the shims 34, as is illustrated in FIG. 5.

As in the preceding embodiments, each shim 34 is made of a thermally-insulating material. So that the contact surface between the bearing face 18 of the cold-molding shell 12A with the support face 26 is sufficient, the shims 34 advantageously cover a surface that is smaller than or equal to approximately 10% of the surface of the support face 26.

This embodiment thus makes it possible to replace a hot-molding shell 12B by a cold-molding shell 12A without having to remove the shims 34. In addition, a single set of shims 34 is necessary for this embodiment.

According to a variant embodiment of the invention that is shown in FIG. 6 and that can be applied to any one of the preceding embodiments, a hot-molding shell 12C is designed so that its bearing face has cooled zones 18A and heated zones 18B. For this purpose, the cooled zones 18A are shaped to be directly in contact with the support face 26 of the shell-carrier 24, while the heated zones 18B are shaped to be thermally insulated from the support face 26 of the shell-carrier 24.

FIG. 6 illustrates an application of this variant in the third embodiment of the invention. The heated zone 18B is located here in a lower portion of the shell 12C, while the cooled zone 18A is located here in an upper portion. The bearing face zone 18A that is cooled has housings 36 that are designed to house the shims 34 located opposite to make possible the direct contact between the bearing face 18 and the support face 26. In contrast, the zone 18B of the bearing face 18 that is heated is arranged in the same area as the bottom of the housings 36 of the cooled zone 18A. Thus, this heated zone 18B of the bearing face is separated from the support face 26 to preserve the air layer 33.

The molding device produced according to the teachings of the invention thus makes it possible to execute both a cold-molding method and a hot-molding method with a shell-carrier that is equipped with cooling means.

The invention makes it possible in particular to save energy by insulating the hot-molding shell of the shell-carrier.

The third embodiment makes it possible in particular to reduce the number of operations to perform during a change in method while limiting the number of parts equipping the molding device.

1. Device (11) for molding containers made of thermoplastic material, in particular by blow molding, comprising:
At least one shell-carrier (24), on which an interchangeable molding shell (12A, 12B, 12C) is designed to be mounted, with said shell comprising an inner face (14) equipped with a molding impression (16) and an outer bearing face (18) resting against an inner support face (26) of the shell-carrier (24),
At least one cold-molding shell (12A) whose bearing face (18) is shaped to be directly in contact with the support face (26) of the shell-carrier (24) when it is mounted,
Means (28, 30) for cooling each shell-carrier (24) that makes it possible to cool the associated cold-molding shell (12A) by heat conduction between the support face (26) and the bearing face (18);
the device comprising:
At least one hot-molding shell (12B, 12C) designed to replace the cold-molding shell (12A) on the shell-carrier (24), each hot-molding shell (12B, 12C) being equipped with means (32) for heating the impression (16) that heat at least one heated zone of its bearing face (18);
Thermal insulation means (33, 34) that are interposed between at least the heated zone of the bearing face (18) of the hot-molding shell (12B, 12C) and the support face (26) of the shell-carrier (24).

2. Device (11) according to claim 1, wherein the thermal insulation means comprise an air layer (33) that is preserved between the heated zone of the bearing face (18) of the hot-molding shell (12B, 12C) and the support face (26) of the shell-carrier (24).

3. Device (11) according to claim 2, wherein the air layer (33) is preserved by means of shims (34) that are inserted between the bearing face (18) of the hot-molding shell (12B, 12C) and the support face (26) of the shell-carrier (24).

4. Device (11) according to claim 3, wherein each shim (34) is made of a thermally-insulating material such as the glass fiber.

5. Device (11) according to claim 3, wherein the shims (34) cover less than 10% of the surface of the support face (26) of the shell-carrier (24).

6. Device (11) according to claim 3, wherein the shims (34) are attached to the shell-carrier (24).

7. Device (11) according to claim 3, wherein the bearing face (18) of the cold-molding shell (12A) comprises housings (36) of a shape that is complementary to the shape of the shims (34) to allow the bearing face (18) of the cold-molding shell (12A) to be brought into contact with the support face (26) of the shell-carrier (24) to which the shims (34) remain attached.

8. Device (11) according to claim 1, wherein the cooling means are designed to cool the entire surface of the support face (26) of the shell-carrier (24).

9. Device (11) according to claim 1, wherein the thermal insulation means cover the entire bearing face (18) of the hot-molding shell (12B).

10. Device (11) according to claim 1, wherein the bearing face (18) of the hot-molding shell (12C) comprises at least one cooled zone (18A) that is directly in contact with the support face (26) of the shell-carrier (24) to be cooled by the cooling means.

11. Device (11) according to claim 1, wherein the means for cooling the shell-carriers (24) are formed by at least one channel network (28) in which a coolant (30) circulates.

12. Device (11) according to claim 1, wherein the means for heating each hot-molding shell (12B, 12C) are formed by at least one electric heating resistor (32) housed in the thickness of the hot-molding shell (12B, 12C).

13. Device (11) according to claim 4, wherein the shims (34) cover less than 10% of the surface of the support face (26) of the shell-carrier (24).

14. Device (11) according to claim 4, wherein the shims (34) are attached to the shell-carrier (24).

15. Device (11) according to claim 5, wherein the shims (34) are attached to the shell-carrier (24).

16. Device (11) according to claim 4, wherein the bearing face (18) of the cold-molding shell (12A) comprises housings (36) of a shape that is complementary to the shape of the shims (34) to allow the bearing face (18) of the cold-molding shell (12A) to be brought into contact with the support face (26) of the shell-carrier (24) to which the shims (34) remain attached.

17. Device (11) according to claim 5, wherein the bearing face (18) of the cold-molding shell (12A) comprises housings (36) of a shape that is complementary to the shape of the shims (34) to allow the bearing face (18) of the cold-molding shell (12A) to be brought into contact with the support face (26) of the shell-carrier (24) to which the shims (34) remain attached.

18. Device (11) according to claim 6, wherein the bearing face (18) of the cold-molding shell (12A) comprises housings (36) of a shape that is complementary to the shape of the shims (34) to allow the bearing face (18) of the cold-molding shell (12A) to be brought into contact with the support face (26) of the shell-carrier (24) to which the shims (34) remain attached.

19. Device (11) according to claim 2, wherein the cooling means are designed to cool the entire surface of the support face (26) of the shell-carrier (24).

20. Device (11) according to claim 3, wherein the cooling means are designed to cool the entire surface of the support face (26) of the shell-carrier (24).
